(19) United States
(12) Patent Application Publication
(10) Pub. No.: US 2011/0118858 A1
(43) Pub. Date: May 19, 2011

(54) LOCAL STORAGE OF A PORTION OF STREAMED MEDIA ITEMS

(75) Inventors: Benjamin Rottler, San Francisco, CA (US); Allen P. Haughay, Morgan Hill, CA (US)

(73) Assignee: Apple Inc., Cupertino, CA (US)

(21) Appl. No.: 12/618,539

(22) Filed: Nov. 13, 2009

(51) Int. Cl. G06F 17/00; G06F 12/00

(52) U.S. Cl. 700/94; 711/161; 711/E12.001

(57) ABSTRACT

This invention is directed to playing back streamed media items using an electronic device. In particular, this is directed to locally storing one or more clips corresponding to a media item such that the clips can be immediately played back in response to a user request to play back the media item. While the clips are played back, the electronic device can retrieve the remaining segments of the media item from the user's media library as a media stream over a communications network. Once the playback of the clip is complete, the electronic device can seamlessly switch playback to the media stream received from the user's library. The electronic device can authenticate with the remote library using any suitable approach, including for example one or more passwords and tokens.

### BACKGROUND

This is directed to locally storing a portion of a media item to provide faster playback for streaming. In particular, this is directed to locally storing the initial portion of a media item, and streaming the remaining portion such that playback can begin without requiring a minimal buffering delay of the media stream.

Many electronic devices can play back one or more types of media items. For example, an electronic device can play back audio files. As another example, an electronic device can play back video files. The electronic device can access the media files being played back from any suitable source. For example, the device can locally store media files in storage (e.g., on a hard drive or in a solid state drive). To play back locally stored media items, the electronic device can retrieve the locally stored media and direct it to a playback process. As another example, the device can stream media files from a remote source (e.g., a content server operated by a content generator or a content sales point). To play back a remote media files, the electronic device can direct communications circuitry to establish a communications path with the remote content source. Once the communications path has been established, the content source can provide the requested media item to the device. Once the device has locally cached a sufficient amount of the media item, the electronic device can begin streamed media playback.

These approaches, however, may have limitations. In particular, an electronic device can have a limited amount of available storage, which may be exceeded by the user's media library. The user may then be prevented from storing the entire library on the electronic device. This may force the user to select only a subset of the library, and may in turn cause the user to rarely listen to or forget about media items of the user's media library.

Similarly, streaming media can have limitations. In particular, the electronic device can require an active communications path with a content source. In addition, the electronic device may not begin playback until at least the beginning of the media items has been cached. When the electronic device is unaware of the next media item to play back, the electronic device can require undesired pauses between media items. Similarly, when a user skips to a different media item for playback, the electronic device can require a pause during which no media item is played back as the new media item is streamed to the device. This may limit the user's ability to enjoy the user's media library and the user's electronic device.

### SUMMARY

This is directed to locally storing portions of a media item that is streamed to an electronic device. In particular, this is directed to locally storing an initial portion of a media item from a user's library, and requesting a stream of the remaining portion of the media item upon starting local playback of the initial portion.

The media items owned or accessible by a user can be stored in a user's media library. The media library can be stored on any suitable device, including for example on a host device, on a remotely accessed server, in a cloud, or in any other suitable location. The user can store at least some media items of the library on an electronic device so that the user can locally play back the media items. The electronic device can include communications circuitry for remotely connecting to the media library and stream media items to the user's device.

The electronic device can receive and locally store initial portions of media items in the electronic device. When a user then instructs the device to play back a media item, the electronic device can initiate playback of the locally stored portion of media item while requesting a stream from the user's media library for the remaining portion of the media item. The duration of the initial portion of the media item can be selected such that a sufficient amount of the remaining portion of the media item stream can be received and cached by the time playback of the initial portion is completed. This can allow the device to seamlessly switch playback from the initial portion to the streamed remaining portion of the media item.

In some embodiments, the electronic device can remotely connect to the user's library. In some embodiments, the electronic device can instead or in addition connect to a content source (e.g., a content generator or a content point of sale) to stream the media items. To ensure that devices can only stream media items that the user has purchased or to which the user otherwise has legal access, the content source can require an authentication scheme (e.g., a username and password, or a secure token). In some embodiments, the streamed media items can instead or in addition include missing elements that an electronic device must retrieve and locally store from the user's media library (e.g., remove 3 seconds of every 10 seconds of a media item, such that the missing 3 seconds are retrieved and locally stored on the device from a user's media library).

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a schematic view of an electronic device in accordance with one embodiment of the invention;

FIG. 2 is a schematic view of an illustrative communications system including an electronic device and a host device in accordance with one embodiment of the invention;

FIG. 3 is a schematic view of an illustrative display for identifying portions of media items to transfer to an electronic device in accordance with one embodiment of the invention;

FIG. 4 is a schematic view of an illustrative media item data structure having several discontinuous locally stored segments in accordance with one embodiment of the invention.

FIG. 5 is a flowchart of an illustrative process for loading media item portions on an electronic device in accordance with one embodiment of the invention;

FIG. 6 is a flowchart of an illustrative process for playing back a partially streamed media item in accordance with one embodiment of the invention;

FIG. 7 is a flowchart of an illustrative process for integrating a locally stored media portion with a media stream in accordance with one embodiment of the invention;

FIG. 8 is a flowchart of an illustrative process for generating locally stored portions of a media item in accordance with one embodiment of the invention; and

FIG. 9 is a flowchart of an illustrative process for authenticating a request for a stream received by a media library in accordance with one embodiment of the invention.

### DETAILED DESCRIPTION

An electronic device operative to locally store a portion of media items streamed from a user's media library is provided.

A user can own a number of different types of media items, all stored as part of the user's media library. The media library can be stored or located in any suitable location or device, including for example distributed across several locations, or copied over different locations to provide backups. The user can play back media items from the library using any suitable approach, including for example by accessing the media library using a media playback application (e.g., iTunes®, available from Apple Inc. of Cupertino, Calif.). The media playback application can load part or all of the media library to display a listing of the media items of the library. The user can play back a media item from the application using any suitable approach, including for example by selecting a listing corresponding to the media item.

In some cases, a user may own or use a portable electronic device with which the user may wish to play back media items from the user's media library. The portable electronic device can include storage in which at least some media items of the user's media library can be stored. The user can load the media items on the electronic device using any suitable approach, including for example by connecting the electronic device to a host device connected to the user's media library. For example, the host device can use the media playback application to connect to the electronic device and provide a communications path for transferring the media items.

Any suitable number of media items can be loaded on the electronic device. For example, the user can select a subset of the media items of the media library to transfer to the electronic device. In some cases, the electronic device can have access to a communications network, such that the electronic device can remotely access the user's media library. In particular, the electronic device can use the remote access link to stream one or more media items from the media library.

To provide a seamless media playback experience, the electronic device can combine locally stored media and streamed media from the user's media library. For example, the electronic device can store initial portions from some or all of the media items of a user's media library, and stream the remaining portions of the media items. When a user then selects a media item for playback, the electronic device can immediately play back the initial portion that is locally stored while requesting a media stream for the remaining portions of the media item. When the playback reaches the end of the locally stored portion of the media item, the stream may have caught up to the playback and be sufficiently cached to seamlessly switch playback to the stream.

The electronic device can determine the length of the locally stored portion of the media item to store locally using any suitable approach. In some embodiments, the electronic device or the host device can determine the expected minimum communications path (e.g., the expected minimum bandwidth) and select a clip length that ensures that enough of the media item can be cached while the locally stored portion is played back. In some embodiments, the electronic device can instead or in addition determine the stored portion length based on the storage available and the desired number of media items to load on the device. As still another example, the electronic device can determine the desired stored portion length based on a user's interests (e.g., longer c stored portion lip if the user likes the song more, so that the song can more easily be played back with a poor communications path).

The electronic device can receive a media stream from any suitable source. For example, the electronic device can receive a stream from a cloud or a host device that includes the user's media library, such that the media library is actually streamed to the user's device. Alternatively, the electronic device can stream media from a content provider or content point of sale. The content provider or point of sale can determine whether an electronic device is authorized to stream a particular media item using any suitable approach. For example, the content provider or point of sale can include one or more listings of authorized electronic devices or users (e.g., based on a known purchase history for each user). As another example, the electronic device can provide a code or other identification information indicating that the electronic device is an authorized streamer. As still another example, the particular portions of the media item that are locally stored, and the portions of the media item that are streamed can be selected such that the streamed portions are meaningless or are missing significant or important portions that are only available as locally stored.

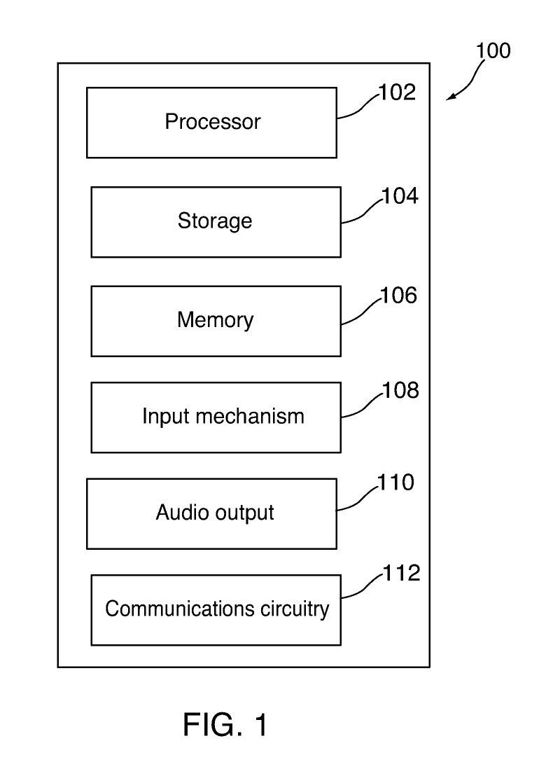

FIG. 1 is a schematic view of a electronic device in accordance with one embodiment of the invention. Electronic device 100 may include processor 102, storage 104, memory 106, input interface 108, audio output 110, and communications circuitry 114. In some embodiments, one or more of electronic device components 100 may be combined or omitted (e.g., combine storage 104 and memory 106, or omit communications circuitry 114). In some embodiments, electronic device 100 may include other components not combined or included in those shown in FIG. 1 (e.g., a power supply or a bus), or several instances of the components shown in FIG. 1. For the sake of simplicity, only one of each of the components is shown in FIG. 1.

Processor 102 may include any processing or control circuitry operative to control the operations and performance of electronic device 100. For example, processor 102 may be used to run operating system applications, firmware applications, media playback applications, media editing applications, or any other application. In some embodiments, a processor may drive a display and process inputs received from a user interface.

Storage 104 may include, for example, one or more storage mediums including a hard-drive, solid state drive, flash memory, permanent memory such as ROM, any other suitable type of storage component, or any combination thereof. Storage 104 may store, for example, media data (e.g., music and video files), application data (e.g., for implementing functions on device 100), firmware, user preference information (e.g., media playback preferences), authentication information (e.g. libraries of data associated with authorized users), lifestyle information, transaction information, wireless connection information, subscription information, contact information, calendar information, and any other suitable information or any combination thereof. Memory 106 can include cache memory, semi-permanent memory such as RAM, and/or one or more different types of memory used for temporarily storing data. In some embodiments, memory 106 can also be used for storing data used to operate electronic device applications, or any other type of data that may be stored in storage 104. In some embodiments, memory 106 and storage 104 may be combined as a single storage medium.

Input interface 108 may provide inputs to input/output circuitry of the electronic device. Input interface 108 may include any suitable input interface, such as for example, a button, keypad, dial, a click wheel, or a touch screen. In some embodiments, electronic device 100 may include a capacitive sensing mechanism, or a multi-touch capacitive sensing mechanism. Audio output 110 may include one or more speakers (e.g., mono or stereo speakers) built into electronic device 100, or an audio connector (e.g., an audio jack or an appropriate Bluetooth connection) operative to be coupled to an audio output mechanism. For example, audio output 110 may be operative to provide audio data using a wired or wireless connection to a headset, headphones or earbuds.

One or more of input interface 108, audio output 110 and a display may be coupled to input/output circuitry. The input/output circuitry may be operative to convert (and encode/decode, if necessary) analog signals and other signals into digital data. In some embodiments, the input/output circuitry can also convert digital data into any other type of signal, and vice-versa. For example, the input/output circuitry may receive and convert physical contact inputs (e.g., from a multi-touch screen), physical movements (e.g., from a mouse or sensor), analog audio signals (e.g., from a microphone), or any other input. The digital data can be provided to and received from processor 102, storage 104, memory 106, or any other component of electronic device 100. In some embodiments, several instances of the input/output circuitry can be included in electronic device 100.

Communications circuitry 112 may be operative to communicate with other devices or with one or more servers using any suitable communications protocol. Electronic device 100 may include one more instances of communications circuitry for simultaneously performing several communications operations using different communications networks. For example, communications circuitry may support Wi-Fi (e.g., a 802.11 protocol), Ethernet, Bluetooth™ (which is a trademark owned by Bluetooth Sig, Inc.), radio frequency systems, cellular networks (e.g., GSM, AMPS, GPRS, CDMA, EV-DO, EDGE, 3GSM, DECT, IS-136/TDMA, iDen, LTE or any other suitable cellular network or protocol), infrared, TCP/IP (e.g., any of the protocols used in each of the TCP/IP layers), HTTP, FTP, RTP, RTSP, SSH, Voice over IP (VOIP), any other communications protocol, or any combination thereof. In some embodiments, communications circuitry 112 may include one or more communications ports operative to provide a wired communications path between electronic device 100 and a host device. For example, a portable electronic device may include one or more connectors (e.g., 30 pin connectors or USB connectors) operative to receive a cable coupling the portable electronic device to a host computer. Using software on the host computer (e.g. iTunes available from Apple Inc.), the portable electronic device may communicate with the host computer.

In some embodiments, electronic device 100 may include a bus operative to provide a data transfer path for transferring data to, from, or between control processor 102, storage 104, memory 106, input interface 108, audio output 110, display 112, communications circuitry 114, and any other component included in the electronic device.

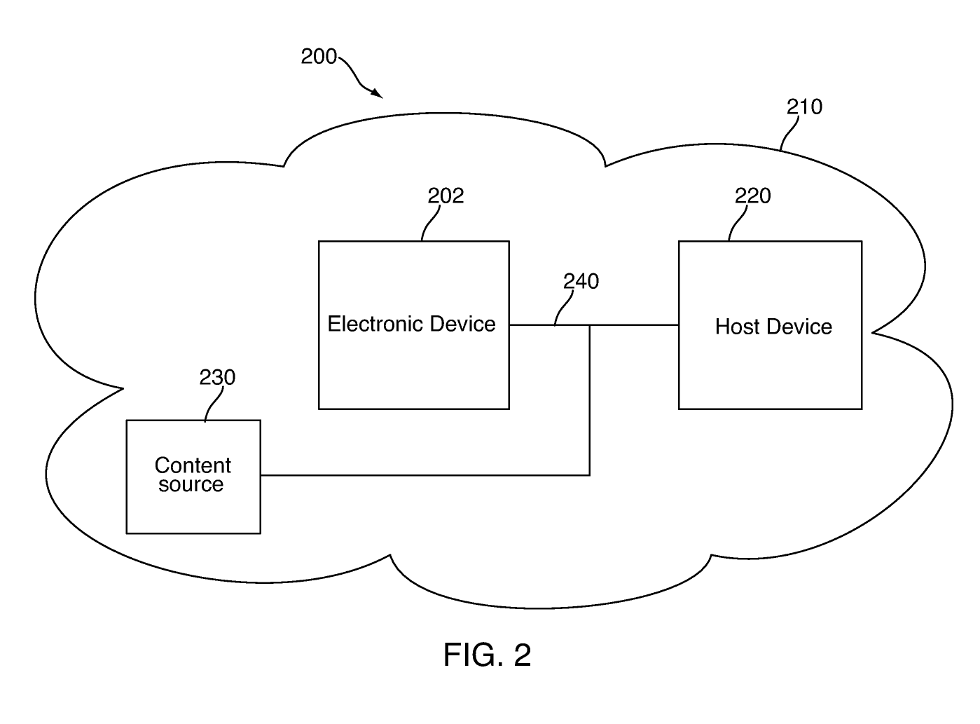

The electronic device can store some or all of a user's media library. For example, the entirety of the user's media library can be located in storage 104. Alternatively, the user's media library can be hosted by another device, and particular media items of the user's library synched to the electronic device. FIG. 2 is a schematic view of an illustrative communications system including an electronic device and a host device in accordance with one embodiment of the invention. Communications system 200 may include electronic device 202 and communications network 210, which electronic device 202 may use to perform wired or wireless communications with other devices within communications network 210. For example, electronic device 202 may perform communications operations with host device 220 over communications network 210 via communications path 240. Although communications system 200 may include several electronic devices 202 and host devices 220, only one of each is shown in FIG. 2 to avoid overcomplicating the drawing.

Any suitable circuitry, device, system or combination of these (e.g., a wireless communications infrastructure including communications towers and telecommunications servers) operative to create a communications network may be used to create communications network 210. Communications network 210 may be capable of providing wireless communications using any suitable short-range or long-range communications protocol. In some embodiments, communications network 210 may support, for example, Wi-Fi (e.g., a 802.11 protocol), Bluetooth (registered trademark), radio frequency systems (e.g., 200 MHz, 2.4 GHz, and 6.6 GHz communication systems), infrared, protocols used by wireless and cellular phones and personal email devices, or any other protocol supporting wireless communications between electronic device 202 and host device 220. Communications network 210 may instead or in addition be capable of providing wired communications between electronic device 202 and host device 220, for example using any suitable port on one or both of the devices (e.g., 30-pin, USB, FireWire, Serial, or Ethernet).

Electronic device 202 may include any suitable device for receiving media or data. For example, electronic device 202 may include one or more features of electronic device 100 (FIG. 1). Electronic device 202 may be coupled with host device 220 over communications path 240 using any suitable approach. For example, electronic device 202 may use any suitable wireless communications protocol to connect to host device 220 over communications path 240. As another example, communications path 240 may be a wired link that is coupled to both electronic device 202 and media provider 220 (e.g., an Ethernet cable). As still another example, communications path 240 may include a combination of wired and wireless links (e.g., an accessory device for wirelessly communicating with host device 220 may be coupled to electronic device 202). In some embodiments, any suitable connector, dongle or docking station may be used to couple electronic device 202 and host device 220 as part of communications path 240.

Host device 220 may include any suitable type of device operative to host a media library and provide media files to electronic device 202. For example, host device 220 may include a computer (e.g., a desktop or laptop computer), a server (e.g., a server available over the Internet or using a dedicated communications path), a kiosk, or any other suitable device. Host device 220 may transfer media files of a media library to an electronic device using any suitable approach. In some embodiments, the host device can run an application dedicated to providing a communications interface between the host device and the electronic device (e.g., iTunes, available from Apple Inc.). Using the application, a user can define the particular subset of media items from the user's media library to load on the electronic device.

The user's media library can be stored on any suitable device. In some embodiments, the media library can be stored entirely or in part in host device 220. Alternatively, the media library can be stored entirely or in part in content source 230. Content source 230 can include any suitable device accessible to one or both of electronic device 202 and host device 220 within communications network 240. In some embodiments, content source 230 can include a cloud in which the user's media library is stored. Alternatively, content source 230 can include one or more remote servers operated by a content provider or sales point. Content source 230 can include only the media items of the user's library, or alternatively include other media items (e.g., all of the media items available from a particular content generator). In some embodiments, system 200 can include several content sources 230, although only one is shown in FIG. 2 to avoid overcomplicating the drawing. The electronic device can receive media streams of media items from the user's library from any device of system 200, including for example host device 220, content source 230, or both.

The electronic device can play back media items from the media library using any suitable approach. In some embodiments, media items can be transferred to the device from a host device that has access to the user's media library. The user can select some or all of the media items of the library for local storage on the device. In some cases, a user may be required to select only a subset of the available media items of the media library due to limited storage resources of the electronic device.

To enhance the user's use of the electronic device, the electronic device can include communications circuitry for remotely connecting to the user's media library and streaming media from the library to the user's device. This may allow the electronic device to play back media items of the user's library that are not locally stored. Depending on the speed of the communications path between the electronic device and the media library, there may be lag between the time the electronic device requests a media stream and when the media stream is sufficiently cached to be played back.

To increase the number of media items available for playback while ensuring that playback can begin as soon as a user selects a media item, the electronic device can store an initial portion of media items of the media library on the electronic device. Then, when a user selects a particular media item to play back, the electronic device can initially play back the locally stored initial portion or clip of media item, and subsequently play back the received media stream from the end of the locally stored portion. The transition from the locally stored portion and the streamed media can be seamless and invisible to the user.

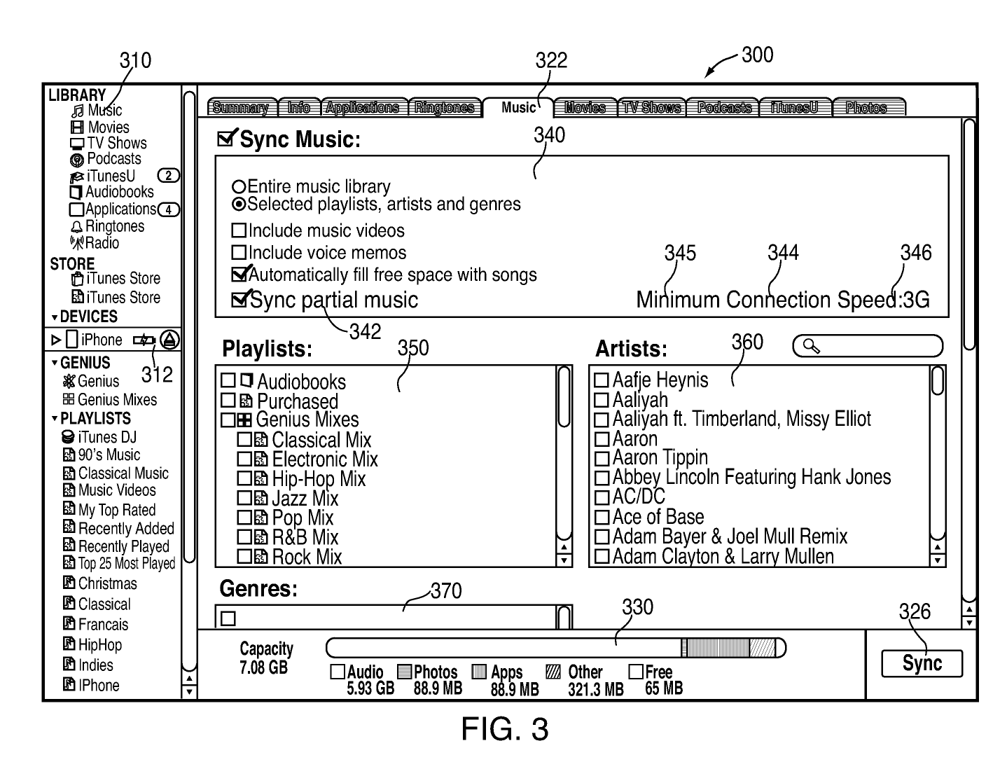

The user can enable partial storage of media items using any suitable approach. In some embodiments, the user can enable a partial storage/streaming option on an application used to define the media items of the user's media library that are to be transferred to the electronic device. FIG. 3 is a schematic view of an illustrative display for identifying clips of media items to transfer to an electronic device in accordance with one embodiment of the invention. Display 300 can include side bar 310 identifying different types of media and devices available to the user's media library. For example, side bar 310 can include options for music, movies, TV shows, audiobooks, radio, or any other type of media. Side bar 310 can instead or in addition including listings identifying electronic devices that are connected to the host device library (e.g., iPhone 312), as well as collections of media items (e.g., collections defined based on one or more seeds or user-defined collections). The user can select any of the options in side bar 310 to direct display 300 to provide corresponding content or information in region 320.

Region 320 can include a series of options related to the particular option selected in side bar 310. For example, in response to receiving a user selection of a “music” option, region 320 can include a listing of available music in the user's media library. In response to a user selection of a device (e.g., iPhone 312), display 300 can include options relating to the content stored on the device, or to the content that a user wishes to store on the device. Region 320 can include tabs 322 defining different types of content of the user's library that the device can store. Such content can include, for example, applications, music, videos, podcasts, photos, personal information (e.g., calendar, mail and contact information), or any other type of content. Because a user's library can include more media than can be stored on the device (e.g., as indicated by device capacity bar 330), the user may be forced to select a subset of the user's available media items to store locally (e.g., using options 340, 350, 360 and 370 of region 320).

In some cases, however, the user may wish to store only portions of media items, such that the electronic device can switch playback between the locally stored portion and media streamed from the media library. This may allow the user to store more media items on the electronic device. Region 320 can include general option 340 having one or more options generally defining the manner in which media items are selected for inclusion on the electronic device. For example, option 340 can include a radio button for selecting whether some or all of the user's library is to synched to the electronic device. Option 340 can instead or in addition include specific options regarding the types of media to load on the electronic device (e.g., music videos and voice memos). In some embodiments, option 340 can allow a user to set how much of the electronic device storage is allocated to media items (e.g., whether or not to fill the storage with music).

In some embodiments, option 340 can include selectable box 342 associated storing only portions of a media item. In particular, in response to receiving a user selection of box 342, the application can select segments of each media item corresponding to the user's selection criteria to store on the electronic device. The host device can select segments of any suitable length, and at any suitable position within the media item for local storage. For example, the media segments or portions can be selected from the beginning of a media item (e.g., the first 30 seconds of a song). As another example, the media segments or portions and include several discontinuous portions of a media item. The host device can determine any suitable length for the media portions. In some embodiments, the host device instead or in addition can automatically elect to store portions of media items on the device. For example, if the electronic has access to a communications network and insufficient storage for storing the entirety of the user's media library, the host device can elect to store at least a portion of the media library as partial clips on the electronic device.

The electronic device can select the media items of the user's media library for which to locally store only initial portions or clips using any suitable approach. In some embodiments, the user can define the particular media items. Alternatively, or in addition, the electronic device can automatically select one or more media items based on a preference profile or other information describing the user's tastes. In some embodiments, the electronic device can dynamically add additional locally stored portions by remotely connecting to a content source or to the user's library until the electronic device has no more available storage (e.g., in the background).

In some embodiments, the length can be determined from characteristics of an expected communications path between the electronic device and the media library located on a remote device or in a remote cloud. The host device can determine the characteristics of the expected connection using any suitable approach. In some embodiments, the user can define the characteristics of the expected connection between the device and the media library. For example, the user can specify values 345 and 346 of phrase 344 defining characteristics of the communications path. The user can enter any suitable value for values 345 and 346, including for example pre-set values selecting from a menu or user defined values (e.g., minimal, average, or maximal for values 345 and Edge, 3G, 5G, or WiFi for values 346). In some embodiments, the values can include a numerical value (e.g., an available bandwidth amount, or a duration required for streaming a known media item).

In some embodiments, the host device can instead or in addition automatically determine the characteristics of the user's expected connection with the media library. For example, the host device can determine the current location of the electronic device, and the available communications networks in the vicinity of the current location. The communications networks can include any suitable type of network, including for example the communications networks described in connection with system 200 (FIG. 2). As another example, the host device can determine characteristics of the communications path from historical data retrieved from the electronic device. In particular, the electronic device can maintain a history of detected communications networks and signal strengths that can be transferred to the host device. The host device can analyze the communications network data to determine characteristics of average or minimal communications paths established by the device. As still another example, the host device can direct the electronic device to establish a test communications path. The host device can detect the test communications path, and use characteristics of the test communications path for the electronic device.

The host device can select any suitable media item segment length based on the determined characteristics of the communications path. For example, the host device can determine, based on the determined characteristics, the time required for streaming a portion of a media item (e.g., for streaming a 6 second segment). The host device can then determine how much of the media item must be locally stored and played back before the communications path can stream a sufficient amount of the media item to the electronic device. The resulting stored portion length can be defined as a percentage of the total media item length (e.g., 20%), duration (e.g., 26 seconds), storage size (e.g., 1 MB), or any other measurement.

In some embodiments, the stored portion length can be the same for all media items, or can vary based on one or more attributes of the media item. For example, a song with a low bitrate can have a shorter locally stored portion than a high bitrate song. As another example, the length of the song may not change the length of the stored portion (e.g., the stored portion is to ensure that sufficient media has been cached by the time playback of the stored portion ends, but the stream can then be used for the entire remaining media item). As another example, the stored portion length can change for music and video. In particular, because video may require more data per unit of time than audio, more of the video can be locally stored on the device.

Because the stored portion length may be less than the entire media item, an electronic device can store a larger number of media items on the device, and give the user the impression of having a large library of media items that can be played back in real time using the electronic device. In particular, in response a user selection of a media item for playback using the electronic device, the electronic device can immediately play back the locally stored portion of the media item (e.g., the beginning of the media item) while requesting a stream from the media library for the remaining portion of the media item. Because the stored portion length was appropriately selected based on the expected communications path, a sufficient amount of the media stream may be received by the time playback of the stored portion ends such that the playback can seamlessly switch from the local portion to the received media stream. If the electronic device has defined a playlist or sequence of media items to play back, the electronic device can request media streams for the media items of the playback sequence in the playback sequence order to ensure that the user's playback experience is smooth.

In some embodiments, the host device can instead or in addition provide a collection of media items to the electronic device. For example, the host device can provide a playlist that includes a preset listing of media items. The playlist can include any suitable number of media items of one or more media types. To allow a user to load an entire playlist on the electronic device, the host device can select a stored portion of the first media item of the playlist for local storage on the device. When the user then selects the playlist for playback, the electronic device can start playback from the locally stored portion, and subsequently stream the remaining portions of the media item, as well as the other media items of the playlist in their entirety. In particular, because the electronic device knows which media items will follow the currently played back media item, the electronic device can request a stream of the entire media item before the currently playing media item ends. Then, only the first media item of the playlist needs to be locally stored. In some cases, if the playback stream is received at a faster rate than expected, the electronic device can skip one or more media items of the playlist without adversely affecting playback (e.g., the media item following the skipped media item may already be at least partially received and cached).

The electronic device can receive a media stream from any suitable source. In some embodiments, the electronic device can request and receive a media stream directly from the user's own media library. For example, the media library can be stored on a host device or server coupled to a communications network. As another example, the media library can be stored in a cloud that the user can access from the electronic device. The electronic device can interface directly with the media library via an API associated with the media library, or can instead or in addition interface with an application accessing the media library. The application can be implemented on the device hosting the media library, or on a different device in communication with the media library.

To prevent unauthorized streaming from a user's media library, a user can define one or more security schemes for the library. In some embodiments, the user can establish an authentication scheme for ensuring that only devices owned by the user and authorized by the user. For example, the media library can require a user name and password combination from the electronic device before providing a media stream. In particular, a user can enter a username and password associated with the media library, which can be checked against a database of authorized usernames and passwords (e.g., username and password combinations for each member of a family). As another example, the media library can provide a media stream to all requesting devices, but encrypt the transmitted media stream using a key that is known only to the user of the electronic device. To avoid denial-of-service type issues, where many unauthorized requests overwhelm the media library, the media library may request and require a response from the electronic device, where the response is a string or other information from the encrypted media stream. The media library and electronic device can use combinations of these or any other suitable authentication or securing scheme to ensure that only the user can access his remote media library.

In some embodiments, the electronic device can instead or in addition retrieve a media stream from a content source other than the user's own library. For example, the electronic device can retrieve a media stream from one or more content generators (e.g., severs associated with media publishers, such as music or video publishers or distributors). As another example, the electronic device can retrieve media streams from an on-line storefront selling the media items (e.g., the iTunes store available from Apple Inc., or the Amazon online music store, available from Amazon.com of Seattle, Wash.).

Because a content generator or content storefront may not wish to stream media items to any requesting electronic device, a system can be implemented such that the content source is assured that the requesting user has purchased the requested content, or is otherwise authorized to access the content. The authorization system can operate in any suitable manner. In one implementation, a content source can be used to sell access to particular media items. When a user purchases access to a media item (e.g., purchases an actual copy of the media item, or purchases a subscription for access to the media item), the content source can retain a record of the purchase. When the user later wishes to stream a media item, the content source can refer to the retained purchase records and determine whether the user is authorized to stream the requested media item. If the user has purchased access to the media item in the past, the user can be authorized to stream the media item.

Although this implementation can be effective, it can be limited in that only media items purchased from the content source can be streamed. If a user rightfully owns other media items purchased from a different source (e.g., music from lawfully purchased CDs), the content source may not authorize a media stream for the media items. In some embodiments, therefore, the content source can receive an initial certified listing of the media items owned by the user, or other information (e.g., one or more tokens) detailing the media items that the user is authorized to play back. To ensure that the user has actual possession of each media item, the user can provide one or more characteristic data associated with the media items (e.g., a sequence of data associated with the media item, such as a hash of a particular media item segment). Alternatively, the user can provide other data certifying the lawful presence of the media in the user's media library. Such data can include, for example, a proof of purchase from a CD, metadata from a particular point of sale (e.g., a transaction number that can be verified in a database made available by the point of sale), or a certification from the content generator (e.g., a signature from a band on music downloaded from the band's website).

In some embodiments, the content source can control a user's ability to enjoy a media stream by adjusting the content of the media stream. In one implementation, the content source can provide a media stream in which substantial, significant, material, or otherwise important or essential portions or segments of the media item are missing. For example, the content source can provide a media stream in which 3 seconds of media are missing for every ten seconds of a media stream. As another example, the media stream can include only a musician's voice but no instruments, a subset of the instruments, only one of several channels (e.g., only one channel in a stereo media item), audio but no video, or any other segment of the media item. As still another example, one or more important segments of the media item can be removed from the stream (e.g., remove all of the chorus and the bridge of a song). The resulting media stream may be incomprehensible to a user, or otherwise of little interest when simply played back. To enjoy the media item in its entirety, an electronic device may require the corresponding missing segments of the media item to be locally stored on the device. Then, when a media item is played back, one or more locally stored portions can be incorporated within the audio stream to complete the media item. In such an implementation, the host device or application providing the media item stored portions to the electronic device can interface with the content source to determine the segments of the media item for which to provide stored portions. In some embodiments, the content source can publish the particular segments that are missing from streamed media items.

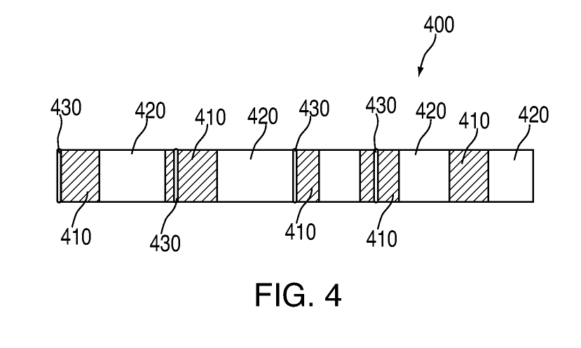

FIG. 4 is a schematic view of an illustrative media item data structure having several discontinuous locally stored segments in accordance with one embodiment of the invention. Media item 400 can be partially stored on the user's electronic device, and partially streamed upon a user request. In one implementation, media item 400 can include several discontinuous segments 410 that are locally stored on the device, and intermediate segments 420 that are streamed between discontinuous segments 410. The electronic device can stream and cache segments 420 such that the device seamlessly switches playback between segments 410 and 420.

The particular portions of media item 400 that are locally stored (e.g., segments 410) can be selected using any suitable approach. In some embodiments, the electronic device can store only a single segment 410 from the beginning of media item 400. As another example, the electronic device can include segments 410 at regular intervals or important portions of the media item (e.g., to provide an authentication scheme). As still another example, the electronic device can include segments 410 starting at or including markers 430 within the media item. In particular, each marker 430 can indicate a chapter marker in an audio book, or other moment to which a user can skip media playback. By providing a segment 410 that includes the marker (e.g., locally storing portions of the media item before and after the marker), a user can skip to a marked playback position and immediately begin playback from the marked position.

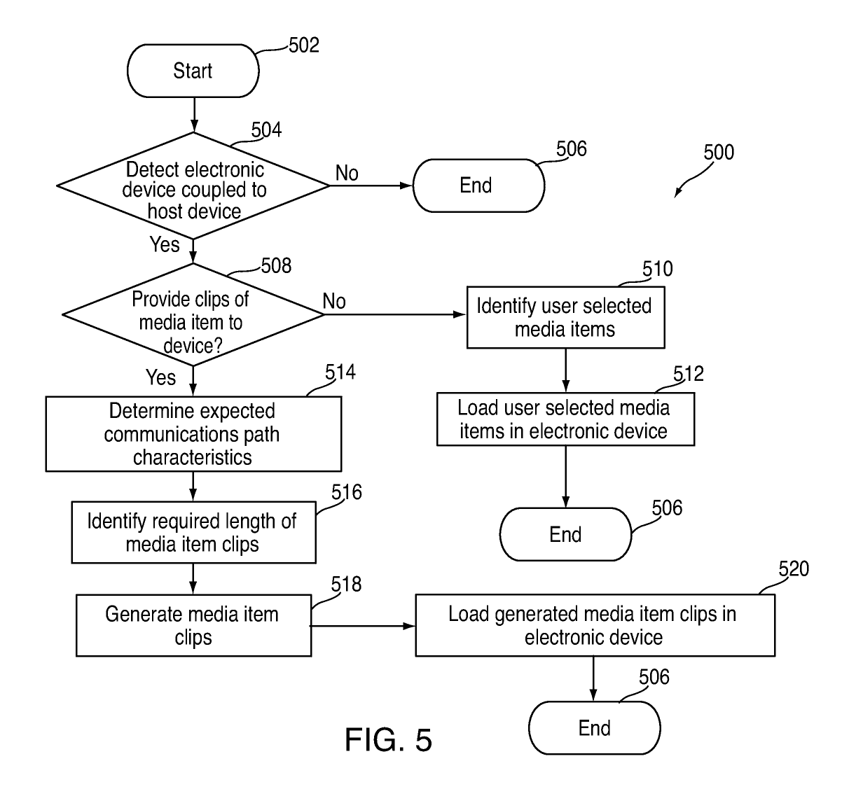

The following flowcharts describe illustrative processes for streaming media items to a user's electronic device from a user's media library. FIG. 5 is a flowchart of an illustrative process for loading media item clips on an electronic device in accordance with one embodiment of the invention. Process 500 can begin at step 502. At step 504, a host device can determine whether an electronic device has been coupled to the host device. For example, the host device can determine whether a particular signal associated with an electronic device coupled via a communications path has been detected. In some embodiments, other components of a communications or media system can detect whether an electronic device is coupled to another device having access to a media library. If the host device determines that no electronic device is coupled to the host device, process 500 can move to step 506 and end.

If, at step 504, the host device instead or in addition determines that an electronic device is coupled to a host device, process 500 can move to step 508. At step 508, the host device can determine whether portions of media items should be provided to the electronic device. For example, the host device can determine whether a setting associated with loading clips of partial media item segments on the device has been selected. As another example, the host device can determine whether the electronic device has access to a communications network, and whether the electronic device storage is insufficient to store the entirety of the user's library. If the host device determines that portions of media items should not be provided to the electronic device, process 500 can move to step 510. At step 510, the host device can identify user selected media items to load in electronic device storage. For example, the host device can identify media items by particular artists, or in particular albums or playlists. At step 512, the host device can load the identified user selected media items in the electronic device storage. For example, the host device can load the available electronic device storage with media items satisfying the user defined selection criteria. Process 500 can then end at step 506.

If, at step 508, the host device instead determines that portions of media items should be provided to the electronic device, process 500 can move to step 514. At step 514, the host device can determine expected communications path characteristics of the electronic device. For example, the host device can receive an indication from the user of expected communications path characteristics. As another example, the host device can automatically determine expected communications path characteristics based on the type of electronic device, the location of the device, historical communications path information, or any other information relating to a communications path used by the device. At step 516, the host device can identify the required length of media item portions to store on the device. For example, the host device can determine, from the expected communications path characteristics, the amount of a media item that can be streamed over the communications path, and select a length such that media playback can seamlessly switch from the local stored portion to a received stream. In particular, the host device can select the media item length such that the media stream corresponding to the remaining segments of the media item can be sufficiently cached for playback by the time the stored portion playback ends.

At step 518, the host device can generate the locally stored portions of media item (e.g., media item clips). For example, the host device can select the initial segment of each media item having the identified required length. In some embodiments, the required length can vary for each media item. For example, a high bitrate media item can have a longer portion than a low bitrate media item. As another example, a locally stored portion can be generates for only the first media item of a sequence of media items to be played in sequence (e.g., a playlist). At step 520, the generated portions of the media item can be loaded in the electronic device. For example, only stored portions of media items corresponding to user define criteria can be loaded (e.g., if the electronic device storage is too limited to store portions of every item of the user's media library). In some embodiments, the host device can load one or more entire media items instead of a portion of media item (e.g., for media items having a rating or other characteristic indicating a strong user interest). Process 500 can then move to step 506 and end.

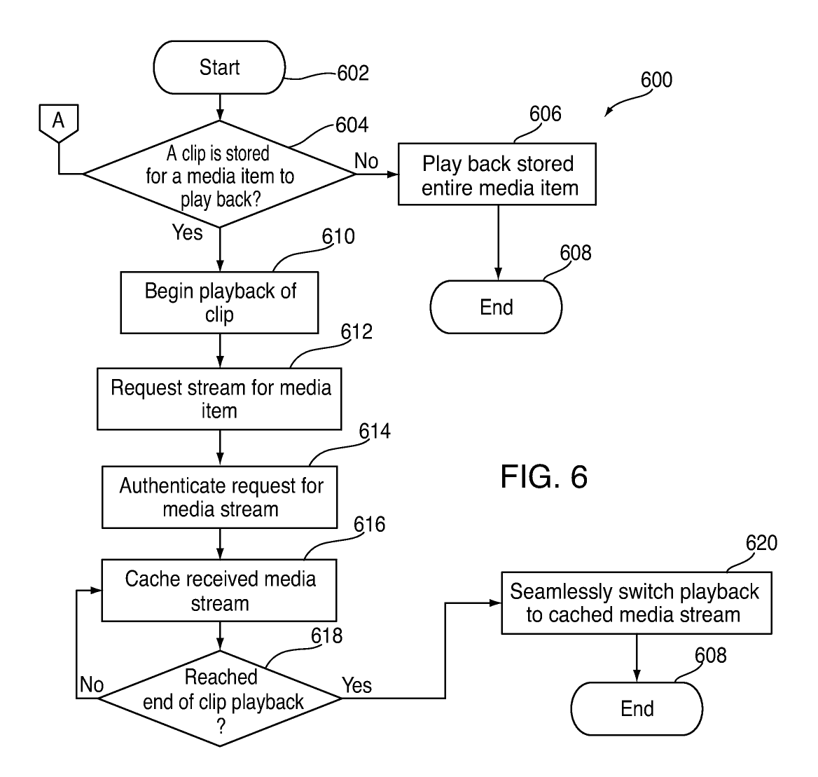

FIG. 6 is a flowchart of an illustrative process for playing back a partially streamed media item in accordance with one embodiment of the invention. Process 600 can begin at step 602. At step 604, the electronic device can determine whether a portion of the media item is locally stored for playback. For example, the electronic device can determine whether a media item selected by the user for playback is stored in its entirety on the device, or only a portion of the media item is locally stored. If the electronic device determines that a portion is not stored, process 600 can move to step 606. At step 606, the locally stored entire media item can be played back. For example, a media playback process can retrieve the media item stored in memory and pass the media item to an audio output component. Process 600 can then end at step 608.

If, at step 604, the electronic device instead determines that a portion is stored for the media item to be played back, process 600 can move to step 610. At step 610, playback of the stored portion of the media item can begin. For example, the electronic device can retrieve from memory the stored portion of a user selected media item to play back, and provide the stored portion to an audio output component. At step 612, the electronic device can request a stream for the remaining segments or portions of the media item. In some embodiments, process 600 can hold off on beginning playback of the stored portion until the electronic device is sure that the requested media stream will be sufficiently cached to ensure a seamless transition between the locally stored portion and the streamed portion of the media item. For example, the electronic device can determine the current characteristics of a communications path with a remote media library (e.g., characteristics of the current communications network), and predict the time required to cache a sufficient amount of the media stream. The electronic device can request the media stream from any suitable source, including for example the user's media library located a remote source, a content provider or generator, a remote point of sale, or any other suitable source for streaming the media item. In the interest of clarity, all of these sources will be referred to as “content sources” in the description of this process.

At step 614, the electronic device can authenticate the request for the media stream. For example, the electronic device can provide identifying information for comparing to records of prior transactions. As another example, the electronic device can provide a token, username and password, or any other suitable authentication string for authenticating with the content source. At step 616, the electronic device can cache the received media stream. For example, the electronic device can store the received media stream in a dedicated playback buffer.

At step 618, the electronic device can determine whether the playback of the locally stored portion of the media item has completed. For example, the electronic device can monitor a playback indicator specifying the current playback position of the media playback process. If the electronic device determines that playback of the stored portion has not completed, process 600 can return to step 616 and continue to cache the received media stream. If, at step 618, the electronic device instead determines that playback of the stored portion has completed, process 600 can move to step 620. At step 620, the electronic device can seamlessly switch playback from the locally stored portion to the cached media stream. For example, the media playback process can seamlessly change the media source to continue to provide an output corresponding to the media item. Process 600 can then end at step 608.

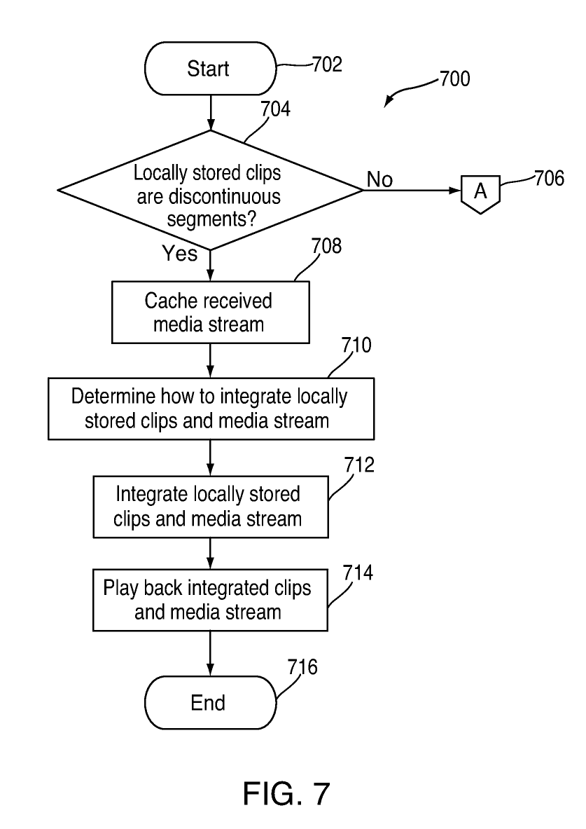

FIG. 7 is a flowchart of an illustrative process for integrating a locally stored media portion with a media stream in accordance with one embodiment of the invention. Process 700 can begin at step 702. At step 704, the electronic device can determine whether locally stored portion or portions of a media item include discontinuous or incomplete segments. For example, the electronic device can determine whether the portions correspond to segments at different playback positions of the media item (e.g., a first 30-second segment 20 seconds into the media item, and a second 30-second segment 2 minutes and 2 seconds into the media item). As another example, the electronic device can determine whether the locally stored portion corresponds to a particular channel or subset of the media item (e.g., a portion includes only the voice channel of the media item). If the electronic device determines that the locally stored portion or portions are not discontinuous segments of the media item, process 700 can move to step 706, which can correspond to step 604 of process 600 (FIG. 6).

If, at step 704, the electronic device instead determines that the locally stored portion or portions include a discontinuous or incomplete segment of the media item, process 700 can move to step 708. At step 708, the electronic device can cache a received media stream corresponding to the media item. For example, the electronic device can store the received media stream in a dedicated buffer. At step 710, the electronic device can determine how to integrate the locally stored portion or portions with the cached media stream. For example, the electronic device can review metadata associated with one or both of the stored portions and the streamed portions to determine how to integrate the stored portion and streamed portion of the media item (e.g., the stream includes metadata specifying when to play back each stored portion along with the stream). As another example, the electronic device can analyze the content of each of the stored portions and streamed portions and determine how to integrate the stored portions and streamed portions (e.g., play back a locally stored portion when the streamed content disappears).

At step 712, the electronic device can integrate the locally stored portion or portions with the cached media stream. For example, the electronic device can pre-assemble the cached streamed and locally stored portions before providing the assembled streamed and local portions to the media playback process as a single media item. As another example, the electronic device can feed the streamed and stored portions to the media playback process at appropriate times such that the media playback process can play back both the streamed and stored portions in an integrated manner. At step 714, the electronic device can play back the integrated stored and streamed portions of the media item. For example, a media playback process can pass the integrated stored and streamed portions of the media item to audio output components. Process 700 can then end at step 716.

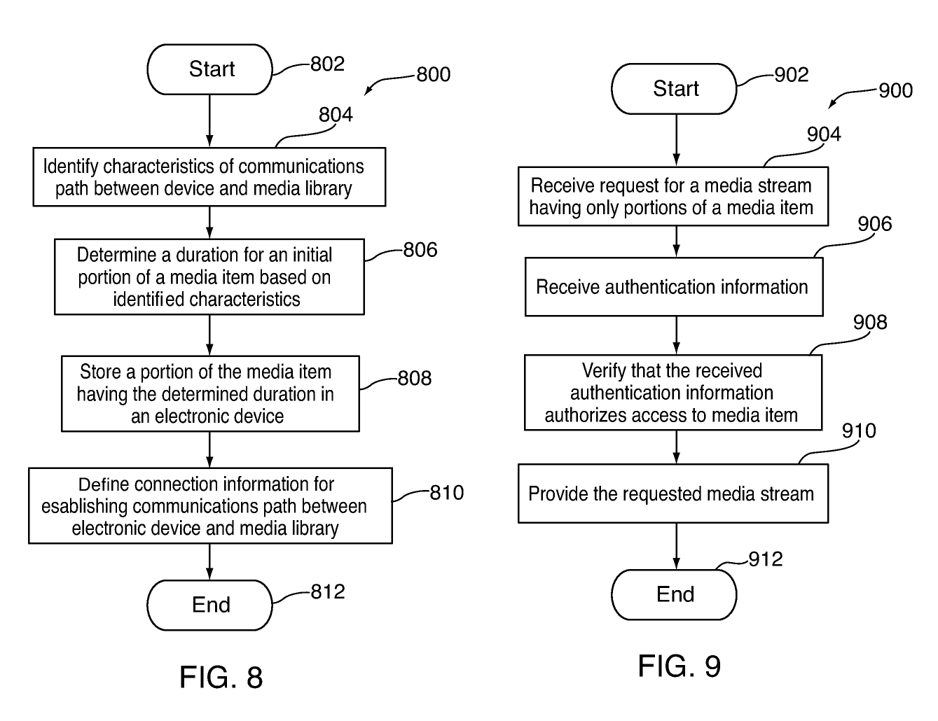

FIG. 8 is a flowchart of an illustrative process for generating locally stored portions of a media item in accordance with one embodiment of the invention. Process 800 can begin at step 802. At step 804, a host device can identify characteristics of a communications path between an electronic device and a user's media library. For example, the host device can receive an indication from the user of expected communications path characteristics. As another example, the host device can automatically determine expected communications path characteristics based on the type of electronic device, the location of the device, historical communications path information, or any other information relating to a communications path used by the device. At step 806, the host device can determine a duration of an initial portion of a media item of the media library based on the identified characteristics. For example, the host device can determine, from the expected communications path characteristics, the amount of a media item that can be streamed over the communications path, and select a length such that media playback can seamlessly switch from the local stored portion to a received stream. In particular, the host device can select the media item length such that the media stream corresponding to the remaining segments of the media item can be sufficiently cached for playback by the time the stored portion playback ends.

At step 808, the electronic device device can store a portion of a media item of the media library, where the duration of the portion of the media item can have the determined duration. For example, the host device can generate and transfer portions of the media item from the host device to the electronic device. At step 810, the host device can define connection information for establishing a communications path between the electronic device and the user's media library, such that the electronic device can stream remaining portions of the media item from the user's library over the communications path. For example, the host device can provide a key or other authentication information to the electronic device. As another example, the host device can provide a particular address at which to access the media library. In some embodiments, the electronic device can instead or in addition provide connection information (e.g., a public key) to the host device or to the media library. Process 800 can then move to step 812 and end.

FIG. 9 is a flowchart of an illustrative process for authenticating a request for a stream received by a media library in accordance with one embodiment of the invention. Process 900 can begin at step 902. At step 904, a content source can receive a request for a media stream from an electronic device. The requested media stream can include only a portion of a media item. For example, the requested media stream can include only remaining portions of a media item, where initial portions of the media item are locally stored by the requesting electronic device. The request can be received over any suitable communications path, including for example a communications path over a network to which the electronic device has access. At step 906, the content source can receive authentication information. For example, the content source can receive a token or password identifying the requesting electronic device. As another example, the electronic device can originate a requested from a secure and known location (e.g., from within a local area network). As still another example, the content source can receive information identifying the electronic device or a user of the electronic device. At step 908, the content source can verify that the received authentication information authorizes the device to access the media item of the requested stream. For example, the content source can compare the received authentication information with a locally stored database of information. As another example, the content source and determine whether the device or user identity is on a list associated with the requested media item. At step 910, the content source can provide the requested media stream to the electronic device. For example, the content source can remove predefined portions of the media item, and stream the remaining portions. As another example, the content source can retrieve from memory pre-set portions of the media items to stream to the electronic device. Process 900 can then end at step 912.

Although many of the embodiments of the present invention are described herein with respect to personal computing devices, it should be understood that the present invention is not limited to personal computing applications, but is generally applicable to other applications.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The above-described embodiments of the invention are presented for purposes of illustration and not of limitation.

What is claimed is:

1. A method for storing media items on an electronic device, comprising:
identifying characteristics of a communications path between the electronic device and a user's media library comprising at least one media item;
determining a duration of an initial portion of the at least one media item from the identified characteristics, wherein the determined duration is less than the duration of the entire at least one media item;
storing a portion of the at least one media item having the determined duration; and
defining connection information for establishing the communications path to the user's media library from the electronic device over which a remaining portion of the at least one media item other than the stored portion can be received.

2. The method of claim 1, wherein identifying further comprises:
identifying at least one communications network available to the electronic device; and
identifying a characteristic data rate associated with the at least one communications network.

3. The method of claim 1, wherein identifying further comprises:
retrieving, from the electronic device, historical information describing characteristics of the communications path with the electronic device.

4. The method of claim 1, wherein determining further comprises:
determining the amount of data transmitted over the communications path having the identified characteristics over a particular amount of time; and
determining a minimum duration during which sufficient amounts of a remaining portion of the at least one media item can be received over the communications path from the media library to seamlessly switch playback from the stored portion to the remaining portion of the media item.

5. The method of claim 4, wherein:
the portion comprises an initial portion of the at least one media item, the playback of which lasts at least the determined minimum duration.

6. The method of claim 1, further comprising:
connecting the electronic device to a host device, wherein the host device has access to the media library.

7. The method of claim 6, further comprising:
providing the characteristics to the host device; and
receiving the portion of the at least one media item from the host device, wherein the host device determines the duration of the stored portion.

8. An electronic device for playing back a media item, comprising control circuitry, communications circuitry, and storage, the control circuitry operative to:
identify a media item to play back;
retrieve from storage at least one stored portion of the identified media item;
direct the communications circuitry to connect to a media library associated with the electronic device, wherein the media library includes the media item;
request from the media library a stream of the remaining portions other than the at least one stored portion of the media item;
play back the at least one stored portion; and
play back the stream of the remaining portions of the media item in addition to the at least one stored portion to play back the entirety of the media item.

9. The electronic device of claim 8, wherein the control circuitry is further operative to:
receive the requested stream; and
integrate the remaining portions of the received stream and the at least one stored portion of the media item.

10. The electronic device of claim 9, wherein the control circuitry is further operative to:
play back at least one stored initial portion corresponding to an initial segment of the media item; and
seamlessly switch playback from the at least one stored initial portion to the remaining portions of received stream following the playback of the at least one initial portion, wherein the remaining portions correspond to a segment of the media item following the initial segment.

11. The electronic device of claim 8, wherein the control circuitry is further operative to:
monitor the received amount of the requested media stream; and
delay playback of the at least one stored portion of the media item until a sufficient amount of the requested media stream has been received.

12. The electronic device of claim 8, wherein the control circuitry is further operative to:
determine the playback position of the at least one stored portion; and
integrate the at least one stored portion and the remaining portions in the requested stream to form the complete media item.

13. The electronic device of claim 12, wherein the control circuitry is further operative to:
sequentially integrate the at least one locally stored portion and the remaining portions.

14. The electronic device of claim 12, wherein the control circuitry is further operative to:
simultaneously play back both at least one stored portion and the remaining portions of the media item, wherein the at least one stored portion and the remaining portions each include different content of the media item.

15. A method for securely transmitting a media stream to an electronic device, comprising:
receiving a request for a media stream that comprises only a portion of a media item from an electronic device;
receiving authentication information with the request;
verifying that the authentication information authorizes access to the media item; and
providing the requested media stream to the electronic device.

16. The method of claim 15, further comprising:
receiving information identifying a user associated with the electronic device;
determining, from purchase records, whether the user has purchased access to the media item; and
providing the requested media stream in response to determining that the user has purchased access to the media item.

17. The method of claim 15, further comprising:
receiving from the electronic device a list of media items from a media library associated with the electronic device;
determining whether the media item is part of the list of media items; and
providing the requested media stream in response to determining that the media item is part of the list of media items.

18. The method of claim 15, further comprising:
selecting a plurality of segments of the media item to remove from the media stream; and
providing the media stream with the removed segments to the electronic device.

19. The method of claim 18, wherein:
the selected plurality of segments comprise at least a plurality of segments corresponding to different playback positions, wherein each segment comprises the entirety of the media item at each playback position.

20. The method of claim 18, wherein:
the selected plurality of segments comprise at least a plurality of segments corresponding to different channels of the media item.

21. A computer readable media for storing media items on an electronic device, the computer readable media comprising computer program logic recorded thereon for:
identifying characteristics of a communications path between the electronic device and a user's media library comprising at least one media item;
determining a duration of an initial portion of the at least one media item from the identified characteristics, wherein the determined duration is less than the duration of the entire at least one media item;
storing a portion of the at least one media item having the determined duration; and
defining connection information for establishing the communications path to the user's media library from the electronic device over which a remaining portion of the at least one media item other than the stored portion can be received.

22. The computer readable media of claim 21, wherein the computer program logic recorded thereon for determining further comprises computer program logic recorded thereon for:
determining the amount of data transmitted over the communications path having the identified characteristics over a particular amount of time; and
determining a minimum duration during which sufficient amounts of a remaining portion of the at least one media item can be received over the communications path from the media library to seamlessly switch playback from the stored portion to the remaining portion of the media item.
